(19) United States
(12) Patent Application Publication
(10) Pub. No.: US 2020/0357182 A1
(43) Pub. Date: Nov. 12, 2020

(54) SYSTEM AND METHOD USING LIGHT SOURCES AS SPATIAL ANCHORS

(71) Applicant: Carnegie Mellon University, Pittsburgh, PA (US)

(72) Inventors: Karan Ahuja, Pittsburgh, PA (US); Sujeath Pareddy, Pittsburgh, PA (US); Bo Robert Xiao, Vancouver (CA); Christopher Harrison, Pittsburgh, PA (US); Mayank Goel, Pittsburgh, PA (US)

(21) Appl. No.: 16/868,061

(22) Filed: May 6, 2020

Related U.S. Application Data
(60) Provisional application No. 62/920,596, filed on May 7, 2019.

(51) Int. Cl. G06T 19/00; G06K 9/00; G06T 1/20

(52) U.S. Cl. CPC G06T 19/006; G06T 1/20; G06K 9/00671

(57) ABSTRACT

A system and method using light sources as spatial anchors is provided. Augmented reality (AR) requires precise and instant overlay of digital information onto everyday objects. Embodiments disclosed herein provide a new method for displaying spatially-anchored data, also referred to as LightAnchors. LightAnchors takes advantage of pervasive point lights—such as light emitting diodes (LEDs) and light bulbs—for both in-view anchoring and data transmission. These lights are blinked at high speed to encode data. An example embodiment includes an application that runs on a mobile operating system without any hardware or software modifications, which has been demonstrated to perform well under various use cases.

### RELATED APPLICATIONS

This application claims the benefit of provisional patent application Ser. No. 62/920,596, filed May 7, 2019, the disclosure of which is hereby incorporated herein by reference in its entirety.

### GOVERNMENT SUPPORT

This invention was made with government funds under Agreement No. HR0011-18-3-0004 awarded by The Defense Advanced Research Projects Agency (DARPA). The U.S. Government has certain rights in this invention.

### FIELD OF THE DISCLOSURE

This application relates to interaction between augmented reality (AR) devices and objects having light sources.

### BACKGROUND

Augmented reality (AR) allows for the overlay of digital information and interactive content onto scenes and objects. In order to provide tight registration of data onto objects in a scene, it is most common for markers to be employed. Various visual tagging strategies have been investigated in both academia and industry (e.g., retroreflective stickers, barcodes, ARToolKit markers, ARTags, AprilTag, QR Codes, and ArUco markers).

There are a wide variety of successful fiducial marking schemes. For example, ARTags use black-and-white two-dimensional (2D) patterns that allow conventional cameras to read a data payload and also estimate three-dimensional (3D) position/orientation of the tag. Other popular schemes include QR Codes, April Tags and ArUco markers. These printed tags are highly visible, and thus often obtrusive to the visual design of objects. In consumer devices, tags are often placed out of sight (bottom or rear of devices), which precludes immediate use in AR applications. To make tags less obtrusive, researchers have explored embedding subtle patterns into existing surfaces, such as floors and walls.

### SUMMARY

A system and method using light sources as spatial anchors is provided. Augmented reality (AR) requires precise and instant overlay of digital information onto everyday objects. Embodiments disclosed herein provide a new method for displaying spatially-anchored data, also referred to as LightAnchors. LightAnchors takes advantage of pervasive point lights—such as light emitting diodes (LEDs) and light bulbs—for both in-view anchoring and data transmission. These lights are blinked at high speed to encode data. An example embodiment includes an application that runs on a mobile operating system without any hardware or software modifications, which has been demonstrated to perform well under various use cases.

LightAnchors can also be used to receive dynamic payloads from objects in AR, without the need for Wi-Fi, Bluetooth or indeed, any connectivity. Devices providing dynamic payloads need only an inexpensive processor, such as a microcontroller, with the ability to blink an LED. This could allow “dumb” devices to become smarter through AR with minimal extra cost. For devices that already contain a microprocessor, LightAnchors opens a new information outlet in AR.

An exemplary embodiment provides a method for detecting spatially-anchored data in AR. The method includes obtaining video data comprising a plurality of frames capturing an environment; for each of the plurality of frames, detecting light spots as candidate data anchors in the environment; tracking the candidate data anchors over the plurality of frames; and decoding at least one of candidate data anchors to extract a corresponding data signal.

Another exemplary embodiment provides a mobile device for detecting spatially-anchored data in AR. The mobile device includes a camera configured to capture video data of an environment; and a processing device. The processing device is configured to: receive the captured video data comprising a plurality of frames; for each of the plurality of frames, detect light spots as candidate data anchors in the environment; and track the candidate data anchors over the plurality of frames to determine one or more data anchors.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A is a photo representation of a mobile device with an exemplary LightAnchors application detecting spatially-anchored data in augmented reality (AR).

FIG. 1B is a photo representation of an exemplary user interface of the LightAnchors application of FIG. 1A.

FIG. 2 is a flow chart illustrating a process for detecting spatially-anchored data in AR.

FIG. 3 is a graphical representation of light intensity measured over time for an example data anchor.

FIG. 4 is a graphical representation of computation time per frame for example mobile devices at different input resolutions.

FIG. 5A is a graphical representation of bit error rate as a function of distance across different lighting conditions.

FIG. 5B is a graphical representation of bit error rate as a function of distance across different movement conditions.

FIG. 5C is a graphical representation of bit error rate as a function of distance across different light sizes.

FIG. 6A is a photo representation of an exemplary application of LightAnchors for a parking meter.

FIG. 6B is a photo representation of an exemplary application of LightAnchors for an exterior light fixture.

FIG. 6C is a photo representation of an exemplary application of LightAnchors for a conference speaker phone.

FIG. 7A is a photo representation of an exemplary application of LightAnchors for a smoke alarm.

FIG. 7B is a photo representation of an exemplary application of LightAnchors for a power strip.

FIG. 7C is a photo representation of an exemplary application of LightAnchors for a WiFi router.

FIG. 8A is a photo representation of an exemplary application of LightAnchors for a light switch.

FIG. 8B is a photo representation of an exemplary application of LightAnchors for a thermostat.

FIG. 8C is a photo representation of an exemplary application of LightAnchors for a payment terminal.

FIG. 9 is a block diagram of the mobile device suitable for implementing the LightAnchors application of FIGS. 1A-1B according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A system and method using light sources as spatial anchors is provided. Augmented reality (AR) requires precise and instant overlay of digital information onto everyday objects. Embodiments disclosed herein provide a new method for displaying spatially-anchored data, also referred to as LightAnchors. LightAnchors takes advantage of pervasive point lights—such as light emitting diodes (LEDs) and light bulbs—for both in-view anchoring and data transmission. These lights are blinked at high speed to encode data. An example embodiment includes an application that runs on a mobile operating system without any hardware or software modifications, which has been demonstrated to perform well under various use cases.

LightAnchors can also be used to receive dynamic payloads from objects in AR, without the need for Wi-Fi, Bluetooth or indeed, any connectivity. Devices providing dynamic payloads need only an inexpensive processor, such as a microcontroller, with the ability to blink an LED. This could allow “dumb” devices to become smarter through AR with minimal extra cost. For devices that already contain a microprocessor, LightAnchors opens a new information outlet in AR.

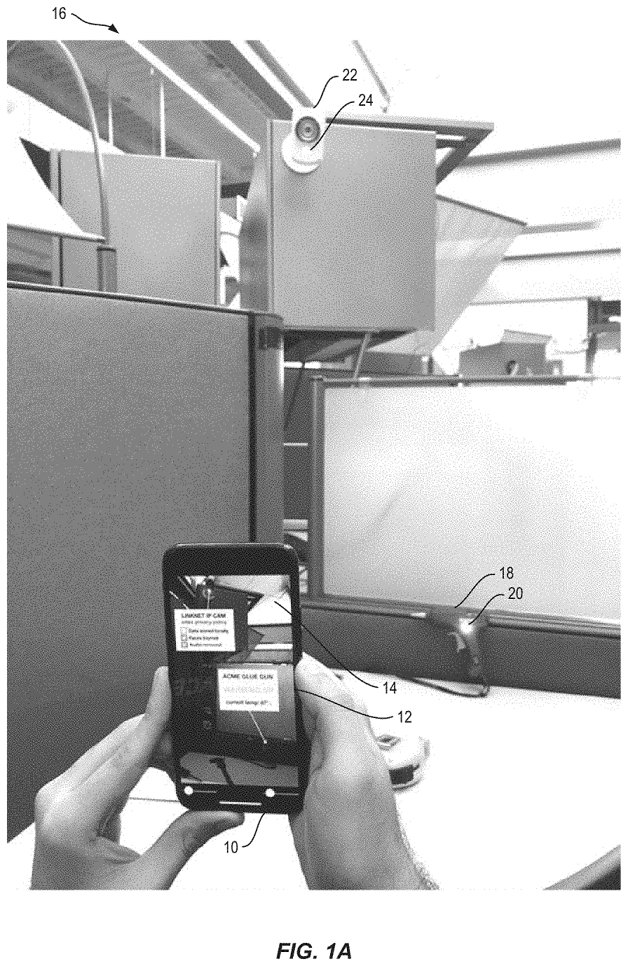

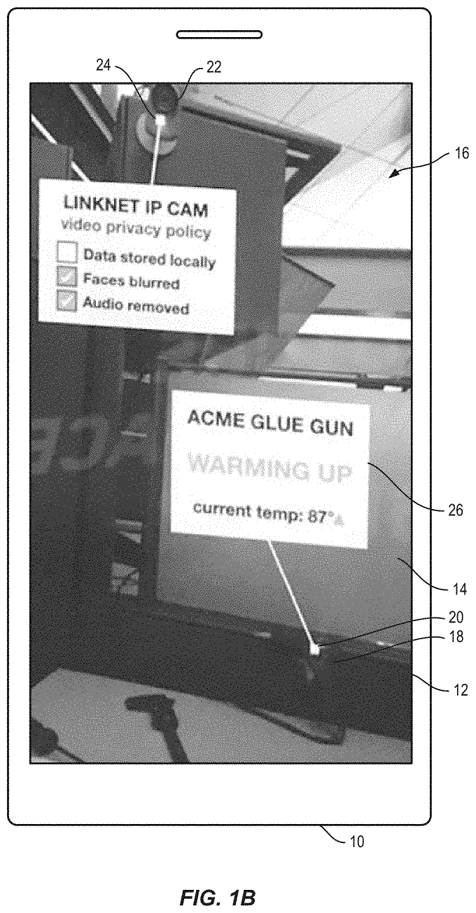

FIG. 1A is a photo representation of a mobile device 10 with an exemplary LightAnchors application 12 detecting spatially-anchored data in AR. The mobile device 10 (e.g., a handheld computer, such as a smartphone, a wearable device, such as an AR headset, etc.) includes a camera which can acquire video data 14 capturing an environment 16 which includes objects incorporating one or more light-based data anchors. For example, the environment 16 captured by the mobile device 10 depicted in FIG. 1A includes a glue gun 18 incorporating a first light source 20 and a security camera 22 incorporating a second light source 24.

The LightAnchors application 12 processes the acquired video data 14 to detect light spots (e.g., from the first light source 20 and/or the second light source 24), which may be identified as candidate data anchors. Such candidate data anchors are tracked over time (e.g., across frames of the video data 14) to determine actual data anchors and extract data related to the corresponding objects (e.g., the glue gun 18 and the security camera 22). In this regard, using the LightAnchors application 12, the mobile device 10 can display spatially-anchored data in AR applications.

Accordingly, the LightAnchors application 12 can take advantage of point lights already found in many objects and environments. For example, most electrical appliances now feature LED status lights (e.g., the second light source 24 of the security camera 22), and light bulbs are common in indoor and outdoor settings. In addition to leveraging these point lights for in-view anchoring (e.g., attaching information and interfaces to specific objects), these lights can be co-opted for data transmission (e.g., blinking the second light source 24 rapidly to encode binary data).

Another difference from conventional markers is that the light sources 20, 24 can be used transmit dynamic payloads. Devices which do not already have an adaptable processor or other controller (e.g., the glue gun 18) need only include an inexpensive microcontroller (e.g., the ATtiny10 from Microchip Technologies, Inc., which costs less than $1 USD) with the ability to blink an LED. This could allow “dumb” devices to become smarter through AR with minimal extra cost (e.g., much less than adding a screen to the device).

FIG. 1B is a photo representation of an exemplary user interface 26 of the LightAnchors application 12 of FIG. 1A. The user interface 26 may present contextual information, including dynamic information, about objects in the environment 16 by extracting data signals from data anchors (e.g., the first light source 20 and the second light source 24). For example, the glue gun 18 can transmit identifying information, its live temperature, and/or operating status to be presented via the user interface 26 of the LightAnchors application 12. As another example, the security camera 22 can use an existing processor-controlled status light to transmit its privacy policy to be presented via the user interface 26.

### Implementation

A device, such as the mobile device 10 of FIGS. 1A-1B, implements the LightAnchors application 12 with an image processing algorithm. At a high level, for every incoming frame of video, the algorithm creates an image pyramid, such that lights—big or small, close or far—are guaranteed to be contained within a single pixel in at least one level. The algorithm then searches for candidate light anchors using a max-pooling template that finds bright pixels surrounded by darker pixels. The algorithm then tracks candidate anchors over frames, decoding a blinked binary pattern using an adaptive threshold. To drop false positive detections, only candidates with the correct preamble are accepted, after which their data payloads can be decoded. This process allows for robust tracking and decoding of multiple data anchors simultaneously.

In an exemplary aspect, all data is encoded as a binary sequence, prefixed with a known pattern (e.g., a preamble and/or postamble). The same message may be repeatedly transmitted such that the preamble pattern appears at the beginning and the same or a different pattern appears as a postamble at the end of every transmission, which makes payload segmentation straightforward. In some examples, the light source (e.g., the first light source 20 or second light source 24 of FIGS. 1A and 1B) is modulated with the preamble pattern between high and low intensities at 120 frames per second (FPS) using a controller (e.g., a microcontroller such as the Teensy 3.6 or Arduino Mega) and a digital-to-analog converter (DAC). The modulation frequency of 120 FPS is at the human flicker fusion threshold, where the flashing can be perceptible depending on the particular payload. In some examples, the modulation frequency may be higher (e.g., 240 FPS) such that the encoding may be imperceptible.

Unlike prior approaches that synchronize light modulation with radio frequency (RF) or other triggers, in embodiments described herein the light sources and AR device (e.g., the mobile device 10 of FIGS. 1A and 1B) may be unsynchronized. This means it is possible for the camera shutter to align with transitions in the blinked pattern, which at best reduces signal-to-noise ratio (SNR), and at worst, means the pattern is unresolvable. To prevent this type of failure, some embodiments phase shift the transmitted signal (e.g., by 36°) after each transmission. It should be understood that while examples are described with reference to basic binary transmission, other embodiments may use multiple illumination levels and colors for data anchoring and transmission.

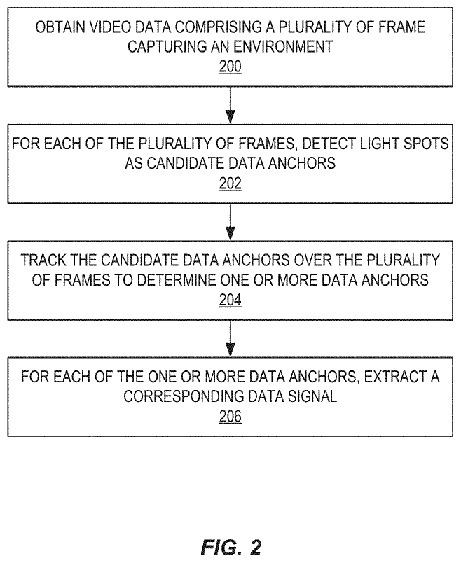

FIG. 2 is a flow chart illustrating a process for detecting spatially-anchored data in AR. The process begins with obtaining video data comprising a plurality of frames capturing an environment (block 200). The video data can be obtained as raw video data, which may be converted from analog to digital and stored as a plurality of video data frames.

Next, the process includes, for each of the plurality of frames, detecting light spots as candidate data anchors in the environment (block 202). The LightAnchor detection algorithm is designed to have high recall. Given a raw video frame, it is first converted to grayscale, and an image pyramid (five layers, scaling by half) is constructed. Candidate data anchors can be modeled as bright spots surrounded by darker regions. Specifically, for each pixel, a difference between the center pixel value and the maximum value of all pixels in a 4×4 diamond perimeter is computed. This result is thresholded at every pixel and at every pyramid level, which produces an array of candidate anchors for each incoming frame of video. Finally, results from all pyramid layers are flattened so that candidate anchors are in the coordinate space of the highest resolution pyramid.

Next, the process includes tracking the candidate data anchors over the plurality of frames to determine one or more data anchors (block 204). The detection process of block 202 passes all candidate anchors to a tracker on every frame, which must be computationally inexpensive in order to maintain a high frame rate. First, proximate candidate data anchors are merged. These may be candidate data anchors which are determined to be too close to be separate data anchors (this often happens when a data anchor is detected at multiple pyramid levels).

The tracker attempts to pair all current candidate data anchors with candidate data anchors from the previous frame using a greedy Euclidean distance matcher with a threshold to discard unlikely pairings. If a match is found, the current point is linked to the previous candidate data anchor, forming a historical linked list. The tracker also uses a time-to-live threshold (e.g., five frames) to compensate for momentary losses in tracking (e.g., image noise, momentary occlusion, loss of focus). Although basic, this approach is computationally inexpensive and works well in practice due to the high frame rate.

Next, the process includes decoding at least one of the one or more data anchors to extract a corresponding data signal (block 206). After each frame is tracked, the process attempts to decode all candidate data anchors. As noted above, the tracker keeps a history of candidate anchors over time, which provides a sequence of light intensity values. Rather than use only the center pixel value, embodiments average light intensity values over a small region, which is less sensitive to camera noise and sub-pixel aliasing during motion.

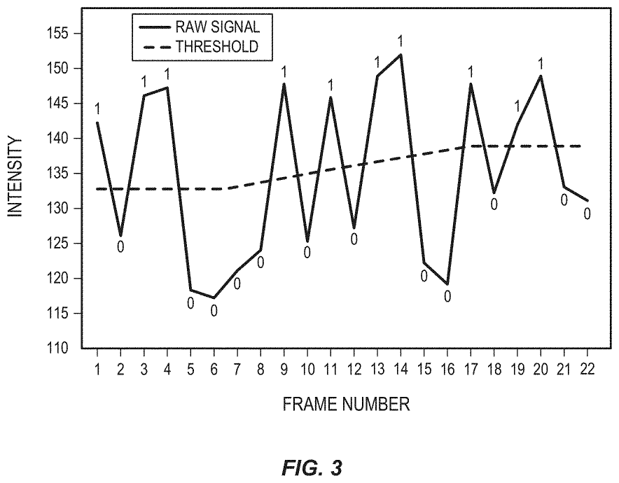

The sequence of light intensity values is converted into a binary sequence using a dynamic threshold. The preamble may contain both 1's and 0's (i.e., high and low brightness), which allows the process to find the midpoint of the minimum and maximum intensity values at both the beginning and end of a transmission. The process linearly interpolates between these two points to produce a binary string, as illustrated in FIG. 3.

FIG. 3 is a graphical representation of light intensity measured over time for an example data anchor. The dynamic threshold used to convert the light intensity values into a binary sequence compensates for low-frequency changes in illumination (e.g., moving cloud cover, user motion, camera auto-exposure adjustment).

Returning to block 206 of FIG. 2, after interpolation, the binary sequence is tested for the presence of the known preamble and/or postamble pattern (e.g., the same or a different pattern which may appear before and/or after a data payload). If the preamble/postamble is missing, the candidate is not decoded (e.g., it might be too early or late to detect, or the tracked point is a static light and not a modulated light anchor). However, if the preamble/postamble is correct, the data payload is stored and used by the LightAnchors application.

An interesting edge case that must be handled is reflections from light-based data anchors (e.g., glints off specular objects, which also appear as point lights). Like true data anchors, these blink valid sequences and are decoded “correctly” by the pipeline. However, they almost always have a lower range of intensities (as they are secondary sources of light), which is used to filter them.

More specifically, if two candidate data anchors are found to have valid, but identical sequences in the same frame, only the candidate with higher signal variance is accepted as a data anchor.

### Performance Analysis

Performance of an example embodiment of the LightAnchors application 12 of FIGS. 1A and 1B is analyzed below. The example embodiment for this analysis uses the AVCaptureSession API to capture video frames and OpenCV for image processing. All video frames are enqueued and consumed asynchronously by the detection-tracking-decoding thread described above with respect to FIG. 2. The example embodiment runs on the iPhone 7 or later, which can capture video frames at 240 FPS/720 p. In some examples, this is too much data to process in real time at high resolutions, and embodiments may drop frames and down sample to an operating resolution. A 240 FPS image stream may require further down sampling (e.g., to 320×180) to be processed in real time. When frames are scaled, the example embodiment for this analysis uses iOS's optimized CoreGraphics API.

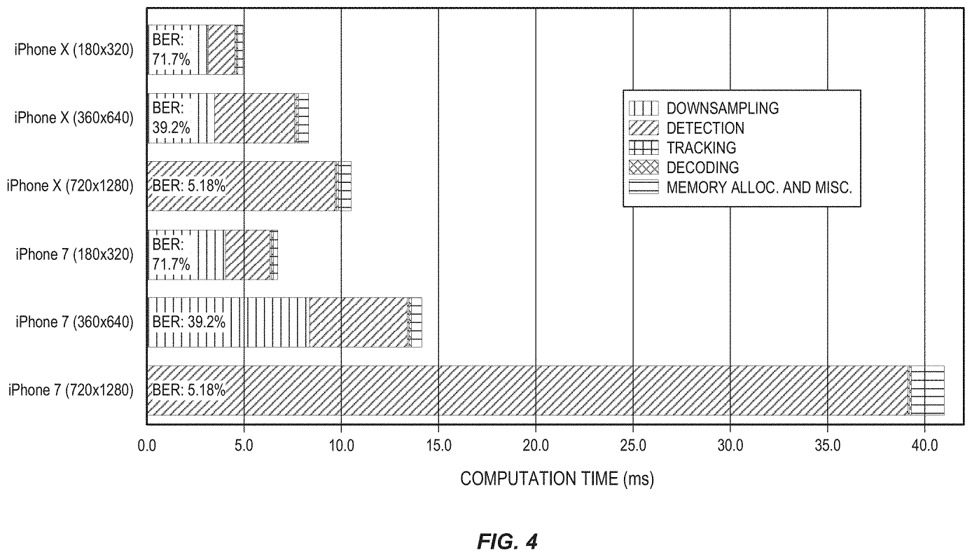

FIG. 4 is a graphical representation of computation time per frame for example mobile devices at different input resolutions. The example embodiment was profiled using XCode on both an iPhone 7 and iPhone X. Different base resolutions (i.e., largest pyramid size) were tested, and for each, three trials were run of 500 frames each. Data was processed at 120 FPS, except for 320×180, which was processed at 240 FPS. Although reducing the image resolution greatly improves processing time, scaling the image becomes a major bottleneck (often making up 50% of the processing). Even though the highly optimized iOS CoreGraphics API was used, this bottleneck can be greatly mitigated with better graphical processing unit (GPU) acceleration. Such GPU acceleration allows LightAnchor detection to run at 240 FPS or more.

### Evaluation

To evaluate the robustness of embodiments described herein, point lights of different size were tested across varying rooms, lighting conditions, and sensing distances. Accuracy was also tested while the device (e.g., the mobile device 10 of FIG. 1) was still and held by a user while walking. This procedure and results are described in detail below.

Evaluation data was captured using an iPhone 7 (720 p at 120 FPS) in three environments: workshop, classroom and office. In each of these settings, the lighting condition was varied: artificial light only (mean 321 lux), artificial light + diffuse sunlight (mean 428 lux) and lights off (mean 98 lux). Data was captured using a tripod (i.e., smartphone held still) and while walking slowly (˜1 meter per second (m/s), to induce some motion blur). Approximately one second of video data was recorded at 2, 4, 6, 8, 10 and 12 meters. For the still condition, a surveyor's rope was used to mark distances, and for the walking condition, a 50 centimeter (cm) printed ArUco tag was used for continuous distance tracking (accepting frames within ±0.5 m). Within each setting, two exemplar point lights were used: a standard 3 millimeter (mm) LED and a larger 100×100 mm LED matrix. These were placed 1.5 m from the ground on a tripod and separated by 120 cm. These two lights simultaneously emitted different (but known) 16-bit light-based data anchors, driven by a single Arduino Mega. For all conditions, the LightAnchors application pipeline ran with a base pyramid size of 1280×720, with 6-bit pre/postambles and 10-bit payloads.

The detection rate did not change substantially across study conditions, and so detection results are combined for brevity. On average, the LightAnchors application found 50.8 candidate anchors (9.0 SD) in each frame. Of course, only two of these were actual data anchors, and the LightAnchors application detected these in all cases (i.e., a true positive rate of 100%).

After the pre/postamble filtering process, the true positive rate was still 100%, but the LightAnchors application found 3.1% false positives. The likelihood of any random pixel in the environment matching the pre/postamble is fairly low. Upon closer analysis of the video data, it appears most of these were actually small reflections of actual data anchors, and thus transmitting correct patterns (an effect discussed above). After applying a variance filter and accepting only the best signal, false positives were reduced to 0.4% and true positives were 99.6%.

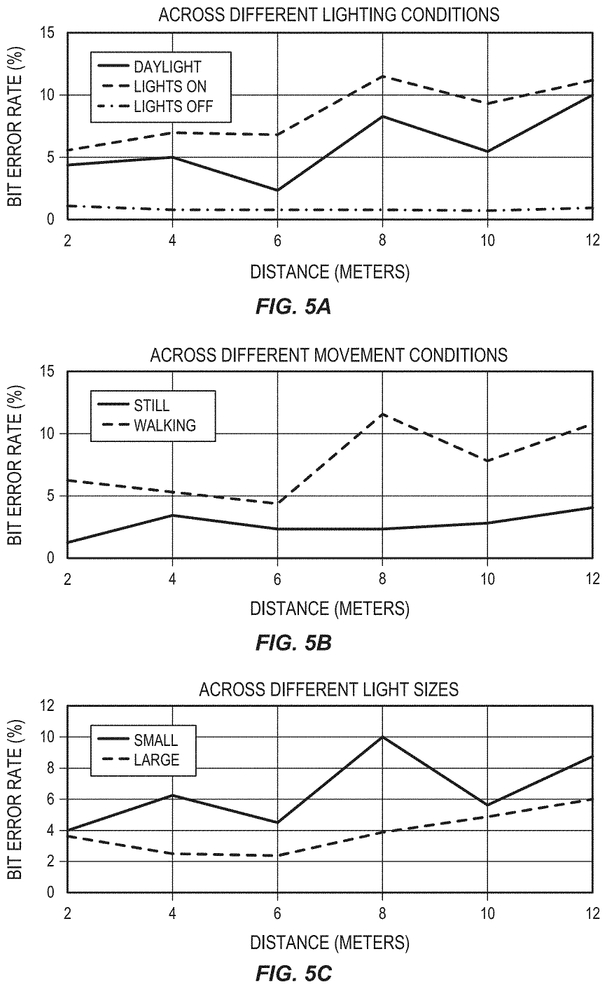

FIGS. 5A-5C illustrate a bit error rate (BER) across different evaluation conditions and distances. FIG. 5A is a graphical representation of BER as a function of distance across different lighting conditions. FIG. 5B is a graphical representation of BER as a function of distance across different movement conditions. FIG. 5C is a graphical representation of BER as a function of distance across different light sizes.

Across all conditions and distances, a mean BER of 5.2% was found, or roughly 1 error in every 20 transmitted bits. Note that this figure includes the 0.4% of false positives that made it through the various filtering stages. Overall, this level of corruption is tolerable and can be mitigated with standard error correction techniques, such as Hamming codes. With respect to light size, the small LED had 6.5% BER, while the larger LED had 3.8% (FIG. 5A). Unsurprisingly, BER was higher while walking (mean 7.7%) than when the camera was still (2.7%), as seen in FIG. 5B. Likewise, errors increased as ambient brightness increased (FIG. 5C).

The BER was also computed across the different base resolutions used in the performance analysis (FIG. 4), and it is clear that high resolution (at least 720 p) is needed to detect, track and decode data anchors accurately.

There are several effects that can cause the LightAnchors application to incorrectly reject data anchors, including poor tracking, motion blur, suboptimal camera-light synchronization, camera sensor noise, and variations in ambient lighting. As discussed above, it is rare for the LightAnchors application to completely miss a visible data anchor, but it is common for a data anchor to have to transmit several times before being recognized. To quantify this, the collected data was used to compute the average time required to detect, track, and decode a data anchor. To do this, the detection pipeline was started at random offsets in the video data and recorded how long it took until data anchors were success-fully decoded.

Across all conditions, a mean recognition time of 464 ms was found. The test data anchor transmissions were 22 bits long (including a 6-bit preamble, 10-bit payload, 6-bit postamble), taking a minimum of 183 ms to transmit at 120 FPS. Because there is no synchronization, detection of a data anchor is almost certainly going to start somewhere in the middle of a transmission, meaning the LightAnchors application will have to wait on average 92 ms for the start of a sequence. The remaining 373 ms in the mean recognition time indicates that, on average, data anchors had to transmit twice before being recognized. It should be noted that this latency varies across conditions. For example, mean recognition latency is 312 ms when the camera was held still (i.e., the first full transmission is often successful) vs. 615 ms when the user was walking (˜3 transmissions before recognition).

### Payload Types and Example Uses

The data payload of data anchors can be used in at least three distinct ways: fixed payloads, dynamic payloads, and connection payloads. To illustrate these different options, as well as to highlight the potential utility of data anchors described herein, eleven demonstration applications are described below. These examples would require no a priori setup of devices and smartphones, and would allow anyone with the LightAnchors application on their mobile device to begin instantly interacting with objects in AR.

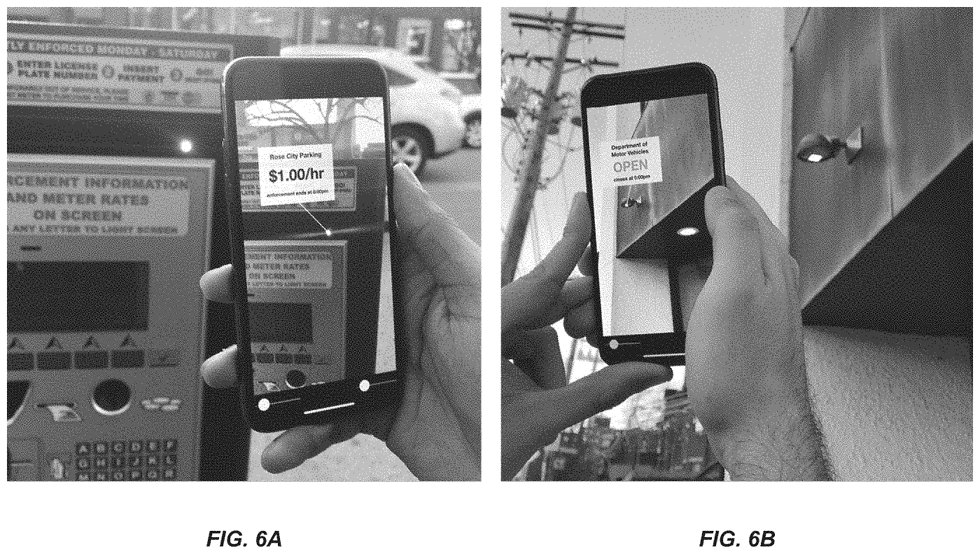

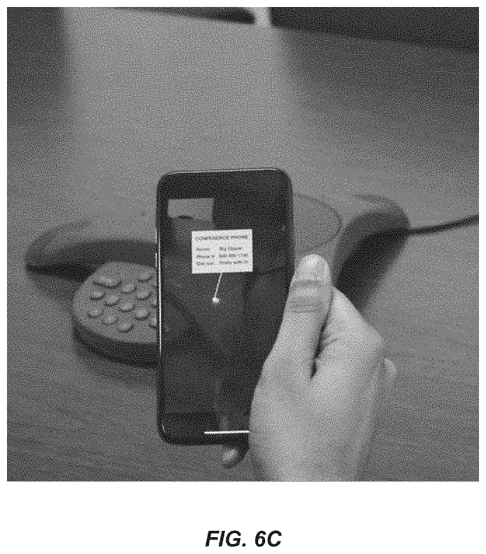

The simplest use of LightAnchors is a fixed payload (similar to fiducial markers), examples of which are illustrated in FIGS. 6A-6C. Although this payload could contain plain text, the limited bitrate of LightAnchors makes this impractical. Instead, embodiments may transmit an identifier (ID) which permits object lookup through a cloud service. Larger payloads (e.g., restaurant name, opening hours, menu, coupons, etc.) could then be fetched over a faster connection (e.g., cellular, Wi-Fi). By utilizing geolocation in the lookup, it may be possible to use fairly small IDs (e.g., 16 bits).

FIG. 6A is a photo representation of an exemplary application of LightAnchors for a parking meter. As a demonstration of a fixed payload, the parking meter is equipped with a light that transmits its enforcement zone ID (from which the rate schedule could be retrieved).

FIG. 6B is a photo representation of an exemplary application of LightAnchors for an exterior light fixture. In this example, an outdoor entrance light is modified to output a fixed ID. From this ID, the LightAnchors user interface displays the building name (Department of Motor Vehicles), its current status (open), and closing time (5 pm).

FIG. 6C is a photo representation of an exemplary application of LightAnchors for a conference speaker phone. In this example a conference room phone is modified to conveniently display its call-in number.

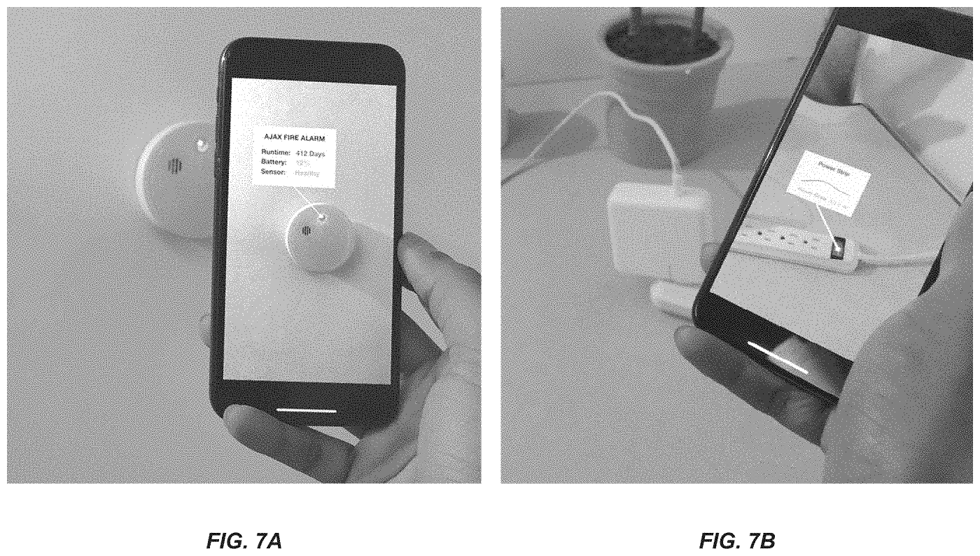

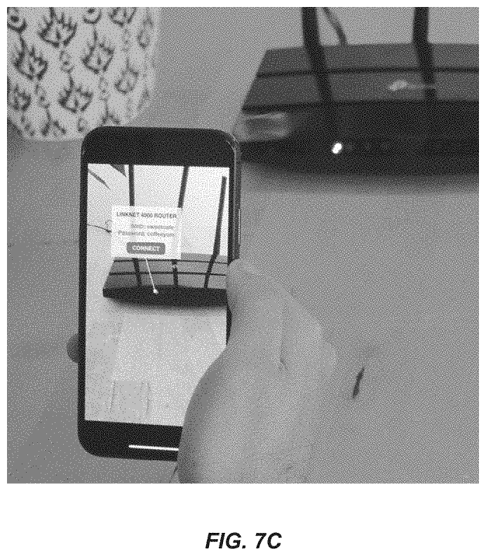

More interesting are dynamic payloads, which can contain a fixed ID that denotes the object, along with a dynamic value, examples of which are illustrated in FIGS. 7A-7C. In a previous example illustrated in FIG. 1B, the glue gun 18 transmits an object identifier (ACME glue gun) and a dynamic value (its live temperature). A typical glue gun contains no digital components, and thus in practice, would require the addition of a microcontroller and thermistor, costing as little as $1 USD.

FIG. 7A is a photo representation of an exemplary application of LightAnchors for a smoke detector. Similar to the glue gun 18 of FIG. 1B, the smoke detector can be modified to include a microcontroller for transmitting its ID and reporting its operating status (e.g., runtime, battery level, sensor condition).

FIG. 7B is a photo representation of an exemplary application of LightAnchors for a power strip. The power strip can be modified to include a microcontroller for transmitting its ID and reporting its power draw.

Of course, many devices (e.g., smart devices) already contain microprocessors or other controllers that can control status lights and could be LightAnchor-enabled with a firmware update. For example, the security camera 22 of FIG. 1B can be updated and its built-in status light can be used to share its privacy policy.

FIG. 7C is a photo representation of an exemplary application of LightAnchors for a WiFi router. Similar to the security camera 22 of FIG. 1B, the WiFi router firmware can be updated to enable transmission of its service set identifier (SSID) and a randomly generated guest password via its status light(s) for the LightAnchors application.

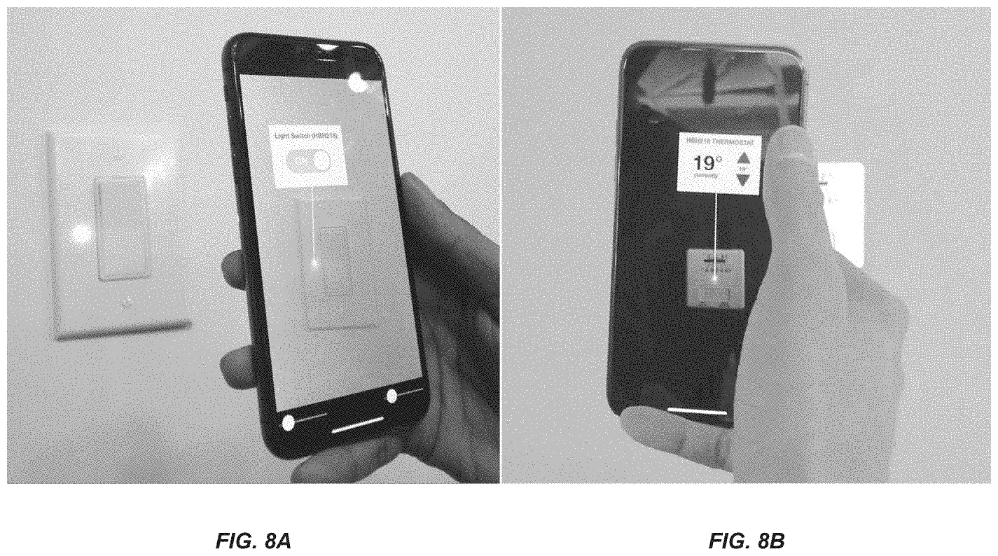

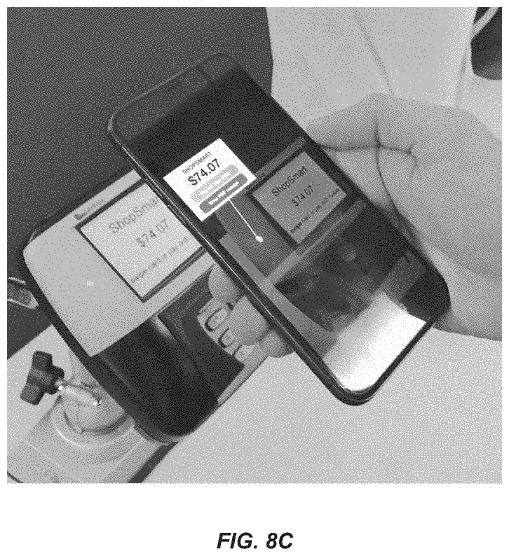

Finally, LightAnchor payloads could be used to provide connection information, examples of which are illustrated in FIGS. 8A-8C. FIG. 8A is a photo representation of an exemplary application of LightAnchors for a light switch. In this example, a smart light switch could provide an IP address, allowing smartphones to open a socket and take remote control of the switch. To mitigate malicious behavior, a token with a short time-to-live could also be transmitted to ensure that users have at least line-of-sight.

FIG. 8B is a photo representation of an exemplary application of LightAnchors for a thermostat. An internet connection could also allow devices to transmit a custom control interface, for example, a small HTML/CSS app. For instance, upon connecting to the smart thermostat of FIG. 8B, a simple temperature control widget could be downloaded and displayed in AR.

FIG. 8C is a photo representation of an exemplary application of LightAnchors for a payment terminal. The payment terminal could allow a smartphone to connect securely over the internet and enable contactless payment.

The biggest drawback of the embodiments described above is limited bitrate, which is chiefly set by smartphone processors and camera FPS. This limits the practical payload size and require care for security issues similar to schemes such as QR codes. Fortunately, high-speed cameras are becoming increasingly commonplace in the market, and some mobile devices can now capture video at 960 FPS or higher. As camera FPS increases, data anchors can blink at higher rates, making the data imperceptible irrespective of the data payload and allow for much larger payloads. Smartphone processors also continue to improve, especially in GPU performance. This allows the LightAnchors application to work with higher video resolutions, which would allow for data anchor detection at longer ranges.

There are also challenges in controlling the exposure and focus of the camera to enable robust tracking. The automatic camera settings on many mobile devices may not be ideal for the LightAnchors application (e.g., causing clipping in dark scenes), and some embodiments lock settings such as exposure. However, embodiments of LightAnchors may function as a passthrough AR experience, where settings that are ideal for LightAnchors may not always be ideal for human users.

Finally, embodiments have been described herein with reference to a single light source for each data anchor. However, LightAnchors can be applied to a known geometry of at least three non-planar data anchors (e.g., status lights on a microwave or Wi-Fi router) which allows for recovery of three-dimensional position in the future. A similar effect might also be achieved using techniques such as structure from motion and simultaneous localization and mapping (SLAM). Such approaches would produce a more immersive AR effect.

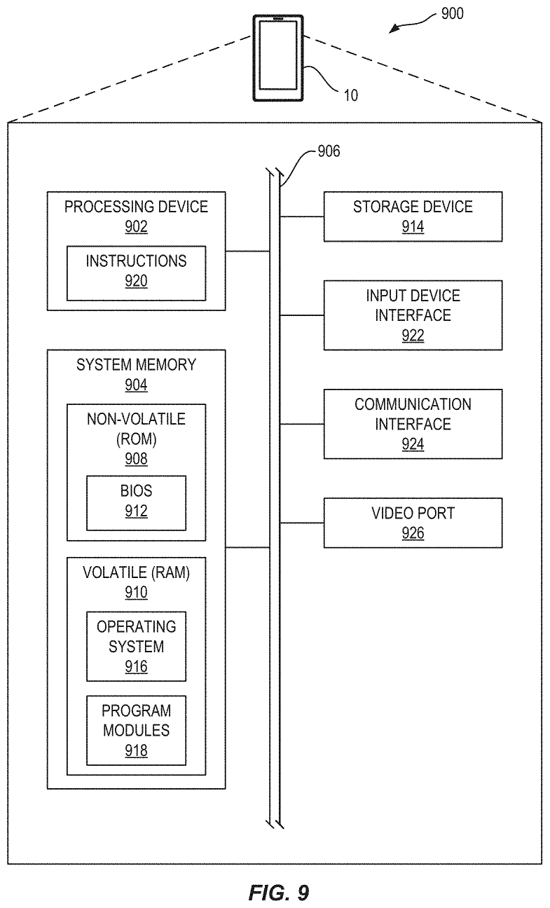

FIG. 9 is a block diagram of the mobile device 10 suitable for implementing the LightAnchors application 12 of FIGS. 1A-1B according to embodiments disclosed herein. The mobile device 10 includes or is implemented as a computer system 900, which comprises any computing or electronic device capable of including firmware, hardware, and/or executing software instructions that could be used to perform any of the methods or functions described above, such as detecting spatially-anchored data in AR. In this regard, the computer system 900 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 900 in this embodiment includes a processing device 902 or processor, a system memory 904, and a system bus 906. The system memory 904 may include non-volatile memory 908 and volatile memory 910. The non-volatile memory 908 may include read-only memory (ROM), erasable programmable read-only memory (EPROM), electrically erasable programmable read-only memory (EEPROM), and the like. The volatile memory 910 generally includes random-access memory (RAM) (e.g., dynamic random access memory (DRAM), such as synchronous DRAM (SDRAM)). A basic input/output system (BIOS) 912 may be stored in the non-volatile memory 908 and can include the basic routines that help to transfer information between elements within the computer system 900.

The system bus 906 provides an interface for system components including, but not limited to, the system memory 904 and the processing device 902. The system bus 906 may be any of several types of bus structures that may further interconnect to a memory bus (with or without a memory controller), a peripheral bus, and/or a local bus using any of a variety of commercially available bus architectures.

The processing device 902 represents one or more commercially available or proprietary general-purpose processing devices, such as a microprocessor, central processing unit (CPU), or the like. More particularly, the processing device 902 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 902 is configured to execute processing logic instructions for performing the operations and steps discussed herein.

In this regard, the various illustrative logical blocks, modules, and circuits described in connection with the embodiments disclosed herein may be implemented or performed with the processing device 902, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 902 may be a microprocessor, or may be any conventional processor, controller, microcontroller, or state machine. The processing device 902 may also be implemented as a combination of computing devices (e.g., a combination of a DSP and a microprocessor, a plurality of microprocessors, one or more microprocessors in conjunction with a DSP core, or any other such configuration).

The computer system 900 may further include or be coupled to a non-transitory computer-readable storage medium, such as a storage device 914, which may represent an internal or external hard disk drive (HDD), flash memory, or the like. The storage device 914 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 916 and any number of program modules 918 or other applications can be stored in the volatile memory 910, wherein the program modules 918 represent a wide array of computer-executable instructions corresponding to programs, applications, functions, and the like that may implement the functionality described herein in whole or in part, such as through instructions 920 on the processing device 902. The program modules 918 may also reside on the storage mechanism provided by the storage device 914. As such, all or a portion of the functionality described herein may be implemented as a computer program product stored on a transitory or non-transitory computer-usable or computer-readable storage medium, such as the storage device 914, non-volatile memory 908, volatile memory 910, instructions 920, and the like. The computer program product includes complex programming instructions, such as complex computer-readable program code, to cause the processing device 902 to carry out the steps necessary to implement the functions described herein.

An operator, such as the user, may also be able to enter one or more configuration commands to the computer system 900 through a keyboard, a pointing device such as a mouse, or a touch-sensitive surface, such as the display device, via an input device interface 922 or remotely through a web interface, terminal program, or the like via a communication interface 924. The communication interface 924 may be wired or wireless and facilitate communications with any number of devices via a communications network in a direct or indirect fashion. An output device, such as a display device, can be coupled to the system bus 906 and driven by a video port 926. Additional inputs and outputs to the computer system 900 may be provided through the system bus 906 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for detecting spatially-anchored data in augmented reality (AR), the method comprising:
obtaining video data comprising a plurality of frames capturing an environment;
for each of the plurality of frames, detecting light spots as candidate data anchors in the environment;
tracking the candidate data anchors over the plurality of frames; and
decoding at least one of the candidate data anchors to extract a corresponding data signal.

2. The method of claim 1, further comprising, for each of the plurality of frames, constructing an image pyramid having multiple levels.

3. The method of claim 2, wherein the image pyramid is constructed such that any light source is guaranteed to be contained within a single pixel in at least one level of the image pyramid.

4. The method of claim 3, wherein detecting light spots as candidate data anchors comprises using a max-pooling template to find bright pixels in the image pyramid which are surrounded by darker pixels.

5. The method of claim 2, wherein the image pyramid is a grayscale image pyramid in which each layer is scaled by half.

6. The method of claim 1, wherein tracking the candidate data anchors comprises merging proximate candidate data anchors which are too close to be separate data anchors.

7. The method of claim 1, wherein tracking the candidate data anchors comprises using a distance matcher across the plurality of frames with a threshold to discard unlikely candidate data anchor pairings.

8. The method of claim 1, wherein tracking the candidate data anchors comprises providing a sequence of light intensity values for each candidate data anchor.

9. The method of claim 8, wherein decoding at least one of the candidate data anchors comprises converting the sequence of light intensity values into a binary sequence comprising the data signal.

10. The method of claim 9, wherein converting the sequence of light intensity values into the binary sequence comprises applying a dynamic threshold based on high and low intensity values in the sequence of light intensity values.

11. The method of claim 1, wherein decoding at least one of the candidate data anchors comprises testing each candidate data anchor for a known preamble.

12. A mobile device for detecting spatially-anchored data in augmented reality (AR), the mobile device comprising:
a camera configured to capture video data of an environment; and
a processing device, configured to:
receive the captured video data comprising a plurality of frames;
for each of the plurality of frames, detect light spots as candidate data anchors in the environment; and
track the candidate data anchors over the plurality of frames to determine one or more data anchors.

13. The mobile device of claim 12, wherein the processing device is further configured to extract a corresponding data signal from at least one of the one or more data anchors.

14. The mobile device of claim 13, wherein the processing device is further configured to present an AR interface comprising information from the corresponding data signal.

15. The mobile device of claim 13, wherein the corresponding data signal comprises a payload and a preamble.

16. The mobile device of claim 15, wherein the payload is a fixed payload.

17. The mobile device of claim 15, wherein the payload is a dynamic payload.

18. The mobile device of claim 12, wherein the processing device is a graphical processing unit (GPU).

19. The mobile device of claim 12, wherein at least one of the one or more data anchors corresponds to a point light source.

20. The mobile device of claim 19, wherein the one or more data anchors correspond to one or more light emitting diodes (LEDs).

21. The mobile device of claim 20, wherein at least one of the one or more LEDs is a status indicator on a smart device.

22. The mobile device of claim 12, wherein at least one of the one or more data anchors corresponds to an area lighting source.

23. The mobile device of claim 12, wherein the mobile device comprises at least one of a smartphone or an AR headset.
